(19) United States
(12) Patent Application Publication
(10) Pub. No.: US 2016/0227960 A1
(43) Pub. Date: Aug. 11, 2016

(54) DUAL SCREEN MILK FROTHER

(71) Applicant: EZ-LATTE, INC., West Palm Beach, FL (US)

(72) Inventors: Paul DellaContrada, West Palm Beach, FL (US); Francisca DellaContrada, West Palm Beach, FL (US); Renan A. Cedeno, Greenacres, FL (US)

(73) Assignee: EZ-LATTE, INC.

(21) Appl. No.: 14/619,568

(22) Filed: Feb. 11, 2015

(51) Int. Cl. A47J 31/44; B01F 3/04

(52) U.S. Cl. CPC A47J 31/4496; B01F 3/04787; B01F 3/04992; B01F 2215/0006; B01F 2003/04865

(57) ABSTRACT

The disclosure is directed toward a milk frothing device having at least two fine mesh screen assemblies in essentially parallel and spaced relationship, constructed and arranged to create a high volume, thick and long-lasting foamy froth from milk.

### FIELD OF THE INVENTION

The present invention relates to devices for frothing milk, particularly to manually operated devices, and most particularly to a milk frothing device having at least two fine mesh screens in essentially parallel and spaced relationship, constructed and arranged to create a high volume, thick and long-lasting foamy froth from milk.

### BACKGROUND OF THE INVENTION

Coffee beverages combined with hot or steamed milk and a foam or froth have been enjoyed for centuries. For example, a cappuccino is a coffee drink composed of espresso and hot milk, with the surface topped with foamed milk. Cappuccinos are most often prepared on an espresso machine. The espresso is extracted into the bottom third of the cup, followed by a similar amount of hot milk, which is prepared by heating and texturing the milk using the espresso machine steam wand. The top third of the drink consists of milk foam; this foam can be decorated with artistic drawings made with the same milk, called latte art.

A latte is a coffee drink made with espresso and steamed milk. The term as used in English is a shortened form of the Italian caffe latte, which means “milk coffee”. The latte or cafe latte is one of the most popular coffees. It is, just like the cappuccino, an espresso based drink topped with milk. The difference between the cappuccino and the latte is mainly the amount of foam.

The crowning touch for either the cappuccino or cafe latte is the foam or froth. Much attention is devoted to proper milk frothing and there are a variety of devices devoted to producing such foams or froths.

The most popular types of stand alone Milk Frothers & Milk Steamers are:

1) Fully Automatic Electric Milk Frothers like the AEROCCINO from NESPRESSO which are capable of making hot steamed milk and producing a rich froth. They use a base similar to an electric kettle for the heat source and a small stainless whisk that stirs and froths the milk while it is heating.

2) Wand Frothers such as the AEROLATTE which will produce foam but will not heat or steam the milk. They operate on batteries and require that the milk be heated on the stove top or in the microwave.

3) Plunger Type Frothers, such as the BODUM LATTEO MILK FROTHER work with cold milk and feature a stainless mesh plunger that is pumped up and down to create the froth. If a hot froth is desired, one can preheat the milk prior to producing the froth.

The problem with current plunger type frothers is that they do not produce a sufficient volume of foam, and the foam is not long-lasting.

The present inventors have developed an improved plunger type frother which includes at least two fine mesh screens in an essentially parallel and spaced relationship, constructed and arranged to create a high volume, thick and long-lasting foamy froth from milk.

### DESCRIPTION OF THE PRIOR ART

U.S Design Patent 401,466 to Joergensen is directed toward a cappuccino maker of the plunger type, having a single screen.

United States Patent Application 20030041739 to Cai, is directed towards a device and method for making beverage from flavor-containing materials and comprises a body connected to a container for allowing the formation of a dispersion of flavor-containing materials in liquid and the extraction of the flavor-containing materials to produce a beverage, a porous filter connected to the body and having a first surface for contacting the dispersion, filtration openings for allowing the beverage in the dispersion to pass through but blocking the flavor-containing materials and a second surface in communication with a beverage outlet from which the beverage may be poured or drunk, and a cling-on chamber on the body adapted to form a vacuum therein to suck to the interior surface of the container, thereby allowing the container to be tilted to generate a liquid head to drive the beverage out of the container through the filtration openings. The device may further include a blending/mixing mechanism to stir or break the flavor-containing materials and liquid for generating a visually appealing crema layer on the dispersion and/or facilitating the extraction of the flavor-containing materials by the liquid, and a flow facilitator having a selective opening for increasing the beverage flow through the filtration openings and preventing the flavor-containing materials in the dispersion from getting out of the container in the event that the dispersion covers the selective opening under a liquid head or force.

United States Patent Application 20100295194, to Bodum et al. discloses a milk frothing apparatus comprising a drive unit (10) which drives a shaft (30). An elongate, flexible, bent frothing element (40) that has an adjustable shape which preferably adjusts to the surface of the liquid to be frothed during operation is connected to the shaft. In a particular embodiment, the frothing element is designed as a flexible helical coil. In addition, another frothing element (32) can be provided at the lower end of the shaft.

U.S. Pat. No. 6,283,625 to Frankel, et al. teaches an apparatus to automatically heat and froth milk for beverages. The apparatus includes a container, a lower paddle group and upper paddle group located above the container bottom. Each paddle group includes at least two paddles. The lower paddle group is adapted to rotate in a direction that is counter to the rotation of the upper paddle group. The apparatus further includes a heater disposed firmly against and below the container bottom.

U.S. Pat. No. 6,796,705 to Khubani is directed toward a frothing mug which includes a mug portion holding a first liquid, a whisk extending into the mug portion, a means for rotating the whisk and a base supporting the mug portion and the whisk and providing the means for rotating the whisk to aerate the liquid. A method of frothing a liquid using the mug includes pouring a quantity of a first liquid into the mug portion such that a portion of the whisk is, or will be, exposed to the air and a portion of the whisk is, or will be, immersed in the first liquid, activating the means for rotating the whisk to froth the liquid and deactivating the means for rotating the whisk after the first liquid is sufficiently frothy.

U.S. Pat. No. 7,669,517 to Boussemart , et al. teaches an appliance for preparing a froth from a milk-based liquid which includes a tank for receiving liquid that is to be frothed, and in which liquid a rotatable stirrer is positioned, a stand associated with the tank, and a system for driving the stirrer. The stirrer drive system and the stirrer include magnetic elements allowing the stirrer to be rotationally driven magnetically in the tank. At least one disturbance member is also provided to break or prevent symmetric circulation of the liquid about the median vertical axis of the tank.

U.S. Pat. No. 8,042,456 to Elissen is directed toward methods and device for frothing milk. The device includes a main body forming a container for the milk, a cover fitting onto the main body, agitation means and drive means for driving the agitation means. The drive means are received at least partially in the cover. The device further includes a base plate provided with a first electric contact. The main body is provided with a second electric contact, which makes electrical contact with the first electric contact when the main body is placed on the base plate. The drive means are provided with a third electric contact. The main body is provided with a fourth electric contact, which makes electrical contact with the third electric contact when the cover is placed on the main body. The main body is provided with an electric conductor which forms an electrical connection between the second electric contact and the fourth electric contact.

U.S Design Patent D382,764 to Brady describes an ornamental design for a container for foaming or frothing milk or milk products.

U.S Design Patent D409,045 to Brady the ornamental design for an in-cup frother.

U.S Design Patent D514,883 to Tardif, et al. describes the ornamental design for a cap and a handle with a stem of a manual milk frother.

The prior art references fail to disclose a milk frothing device having at least two fine mesh screens in essentially parallel and spaced relationship, constructed and arranged to create a high volume, thick and long-lasting foamy froth from milk.

### SUMMARY OF THE INVENTION

The present invention discloses a milk frothing device having at least two fine mesh screens in essentially parallel and spaced relationship, constructed and arranged to create a high volume, thick and long-lasting foamy froth from milk.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 illustrates the plunger assembly inclusive of a reciprocating plunger, multiple fine mesh screens, container cover and plunger handle;

FIG. 2 illustrates a perspective view of the plunger assembly in combination with a containment vessel;

FIG. 3A illustrates a cross-sectional view through line 3A showing the plunger assembly in a first position as it is moved in a downward direction;

FIG. 3B illustrates a cross-sectional view through line 3A showing the plunger assembly in a second position as it is moved in an upward direction;

FIG. 3C illustrates a cross-sectional view through line 3A showing the plunger assembly in a third position as it is again moved in a downward direction;

FIG. 3D illustrates a cross-sectional view through line 3A showing the plunger assembly after it has again traveled in an upward direction, after which it is removed, leaving a froth floating on the surface;

FIG. 4 is a perspective view of the attachment of the multiple fine mesh screens to the reciprocating plunger.

### DETAILED DESCRIPTION OF THE INVENTION

The invention is directed toward an improved plunger type milk frothing device. The milk frothing device has at least two fine mesh screens disposed in essentially parallel and spaced relationship, and constructed and arranged to create a high volume, thick and long-lasting foamy froth from milk when the screens are moved through the milk in a repetitive up-and-down or back-and-forth linear motion, termed a reciprocating motion.

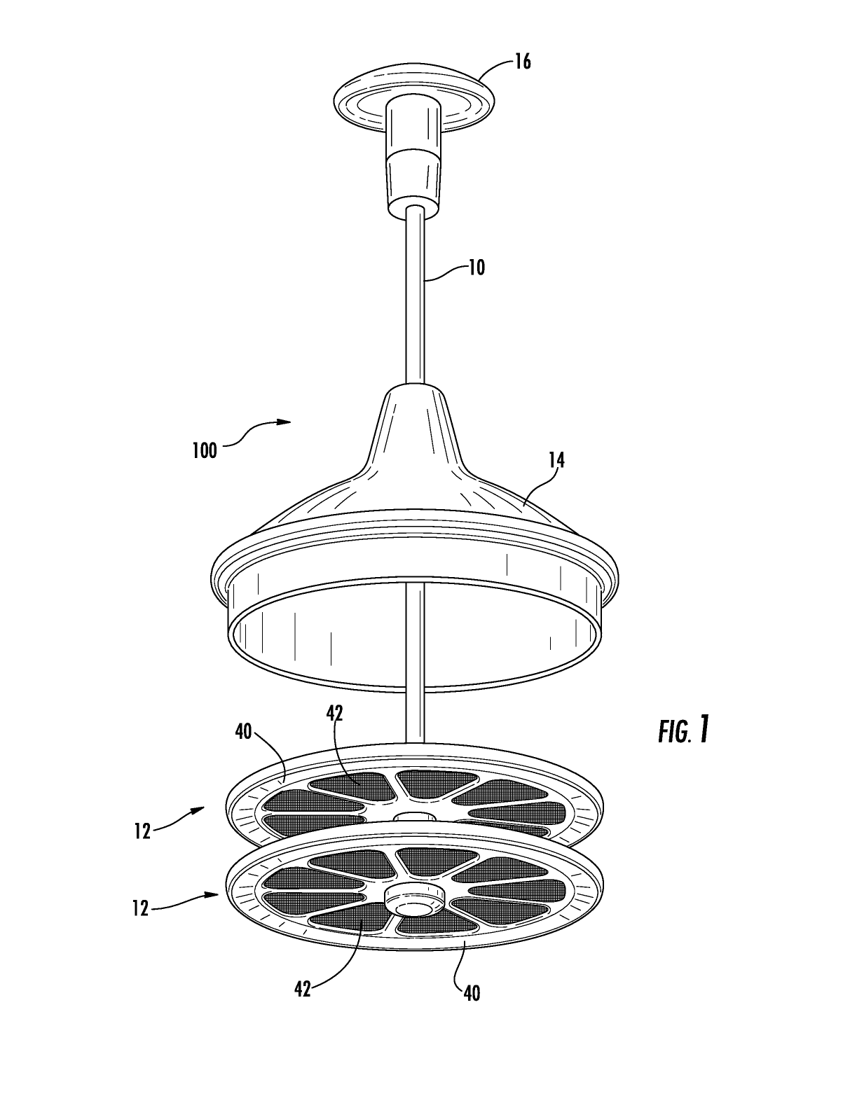

With reference to FIG. 1, plunger type frother assembly assembly 100 is shown, inclusive of a of a reciprocating plunger 10, multiple fine mesh screen assemblies 12 positioned at said plunger's distal end, and a removable plunger handle 16, positioned at said plunger's proximal end. In an embodiment, the plunger type frother assembly may be provided in the form of a kit, inclusive of the screen assemblies 12, a cover 14, removable plunger handle 16 and a containment vessel 20.

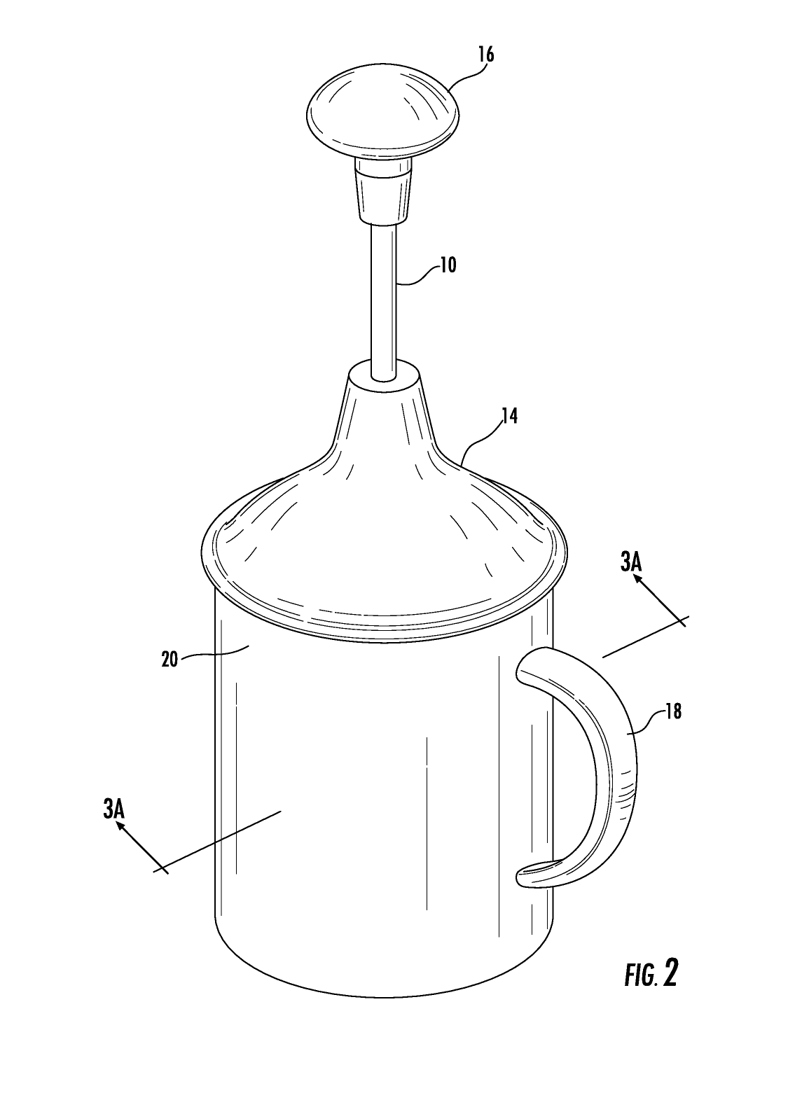

While the overall shape of the components 12,14 and 16 of the plunger assembly are illustrated as being circular, as is the beverage containment vessel 20, as illustrated in FIG. 2, it is emphasized that the circular shape is merely illustrative. It is understood that such shape is not limiting, but merely illustrative, and various embodiments could have alternative shapes, such as oval, square, etc. without departing or detracting from the spirit and scope of the invention.

The spacing of the multiple fine mesh screen assemblies 12 enable the production of a higher volume, longer lasting foam than that produced by a single screen plunger. The arrangement of the mesh screen assemblies 12 should be in a spaced relationship effective to provide a markedly and surprisingly improved degree of aeration and mixing over that which can be realized from a single screen arrangement. In an illustrative, albeit non-limiting embodiment, the spacing between mesh screen assemblies 12 can be in the range of about ¼″-¾″.

In our comparative testing against a single screen assembly embodiment, such as that depicted in the Joergensen Design Patent 401,466, the volume of foam produced by the device of the instant invention was more than double that of the '466 device, and the resultant foam lasted more than four times as long.

### Experiment

The following test was repeated three times, and results were equivalent each time. We conducted a test between a prior art device, substantially similar to the device shown in the '466 design patent, having a single screen assembly, versus the device in accordance with the instant invention containing two screen assemblies in essentially parallel and spaced relationship.

Initially, two 8 oz. glasses of 2% low fat milk were heated for 1 minute 25 seconds each in a microwave oven;

Next, the single screen assembly unit was placed in one glass and the double screen unit in the other;

The plungers were pumped 10 times for each test device, in a reciprocating fashion, after which each screen was removed from the glass.

Then the foam that was produced was measured;
A—The glass containing the single screen produced ½″ foam atop of the rest of the milk;
B—The glass containing the double screen produced 1.25″ foam atop of the rest of the milk.

The foams were observed to measure the length of time it took for the foam to dissipate:
A—The single screen foam only lasted for 10 minutes
B—The double screen foam lasted for 45 minutes

Referring to FIG. 2, a perspective view is shown of the plunger assembly 100 positioned within the containment vessel 20. The containment vessel may be provided with a handle 18.

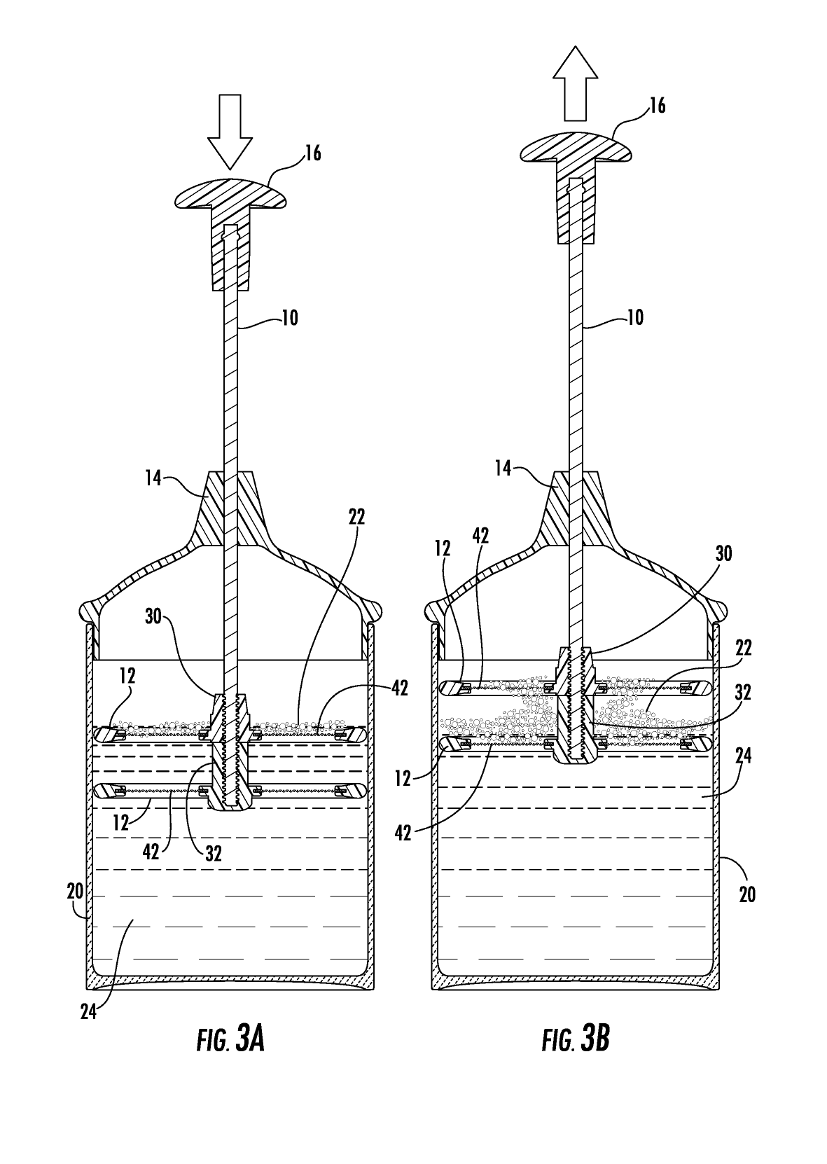

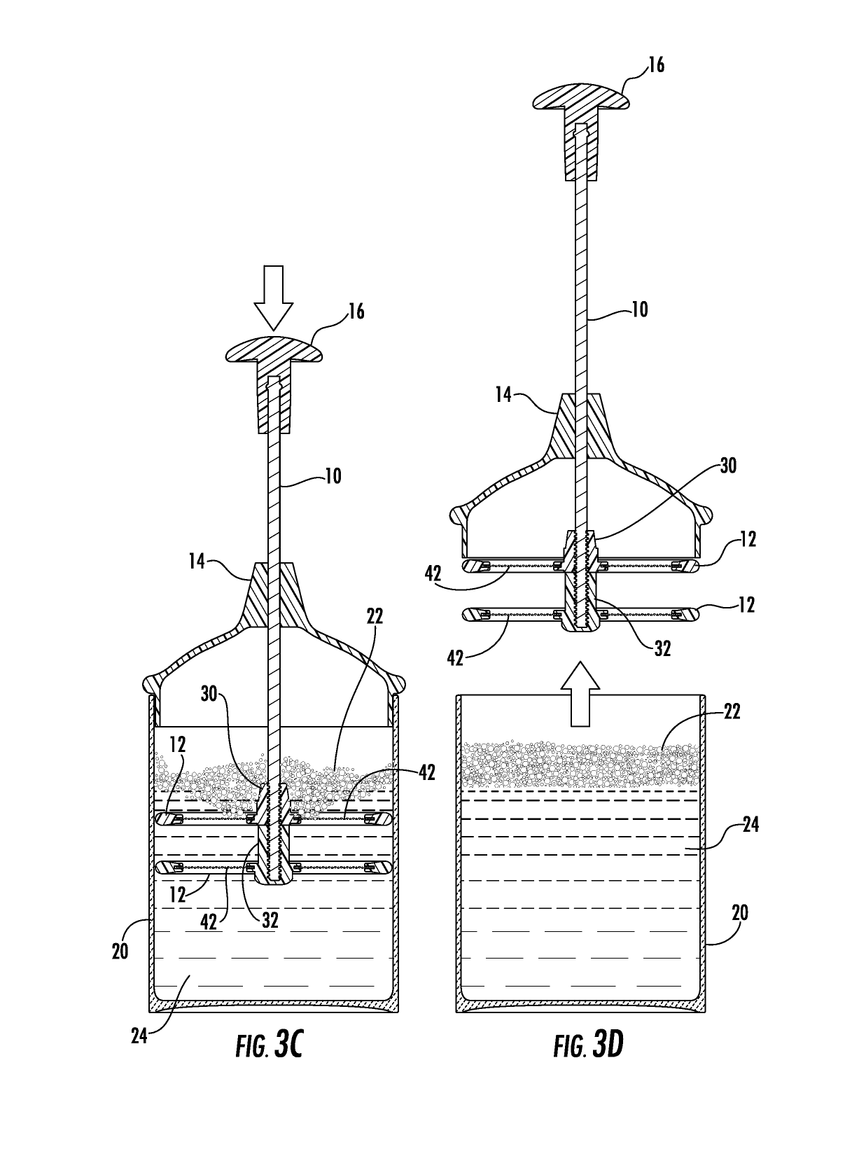

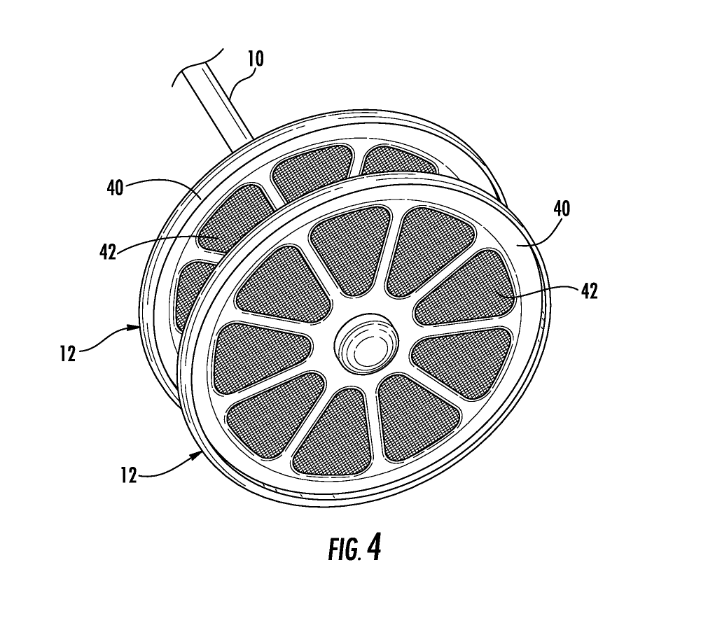

Referring to FIGS. 3A-3D, these figures are a cross-sectional view through line 3A-3A of FIG. 2. The engagement of the fine mesh screen assemblies 12 is illustrated in this view as being in threaded engagement with the distal portion of the reciprocating plunger 10. Threaded abutments 30 and 32 serve to fixedly engage the screen assemblies 12 to the plunger 10, while maintaining the screen assemblies 12 in the desired spaced relation, effective to produce a higher volume of longer lasting foam/froth 22. Although the device is herein depicted as having two screen assemblies 12, it is within the purview of the instant invention to add additional screen assemblies 12 to the combination.

FIG. 3A illustrates a cross-sectional view through line 3A-3A showing the plunger assembly 100 in a first position as it is moved in a downward direction. The beginnings of the foam/froth 22 formation can be seen atop the uppermost screen assembly 12.

FIG. 3B illustrates a cross-sectional view through line 3A-3A showing the plunger assembly 100 in a second position as it is moved in an upward direction. The formation of additional foam/froth 22 can now be seen atop the lowermost screen assembly 12, as well.

FIG. 3C illustrates a cross-sectional view through line 3A-3A showing the plunger assembly 100 in a third position as it is continually reciprocated and the formation of additional foam/froth 22 is in evidence.

FIG. 3D illustrates a cross-sectional view through line 3A-3A showing the plunger assembly 100 after it has been reciprocated the requisite number of times to produce the desired degree of foam/froth 22, after which it is removed, leaving the foam/froth 22 floating on the surface of the milk 24.

FIG. 4 is a perspective view of an embodiment showing the attachment of the multiple fine mesh screen assemblies 12 to the reciprocating plunger 10. This embodiment illustrates the construction of the screen assemblies 12 as containing a frame 40 adapted for receipt of a plurality of fine mesh screens 42, therein. As stated earlier, this rendition is merely illustrative. Any shape for the frame 40 and any number of fine mesh screen inserts 42 is within the contemplation of the invention. Fine mesh screens 42 should have a mesh size effective for producing the long-lasting and voluminous foam/froth as illustrated herein. In an illustrative, albeit non-limiting embodiment, the screen is of a mesh size of about 400 microns. The material from which the fine mesh screens 42 are formed should not rust or corrode, and be sufficiently robust for effective foam production. Any metallic or polymeric mesh material, or any combinations thereof are considered to be within the purview of the instant invention, and are exemplified by, albeit not limited to stainless steel, aluminum, nylon and the like.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A plunger type frother assembly for producing a high volume, long-lasting foamy milk froth comprising:
a reciprocating plunger having a proximal end and a distal end;
a plunger handle situated at said reciprocating plunger proximal end; and
at least two fine mesh screen assemblies positioned at said reciprocating plunger distal end constructed and arranged to maintain said screen assemblies in an essentially parallel and spaced relationship;
whereby movement of said screen assemblies through said milk in a repetitive reciprocating motion produces a high volume, thick and long-lasting foamy froth.

2. The plunger type frother assembly for producing a high volume, long-lasting foamy milk froth in accordance with claim 1 wherein said reciprocating plunger distal end is constructed and arranged to provide threaded engagement with said fine mesh screen assemblies, effective to maintain said screen assemblies in an essentially parallel and spaced relationship.

3. The plunger type frother assembly for producing a high volume, long-lasting foamy milk froth in accordance with claim 1 wherein said fine mesh screen assemblies have a mesh size of about 400 microns.

4. The plunger type frother assembly for producing a high volume, long-lasting foamy milk froth in accordance with claim 1 wherein said fine mesh screen assemblies are formed from a screen selected from a metallic material, a polymeric material, or a combination thereof.

5. The plunger type frother assembly for producing a high volume, long-lasting foamy milk froth in accordance with claim 1 wherein the spacing between said fine mesh screen assemblies is in a range of about ¼″-¾″.

6. The plunger type frother assembly for producing a high volume, long-lasting foamy milk froth in accordance with claim 1 provided in the form of a kit further including a cover and a containment vessel.
